(19) United States
(12) Patent Application Publication
(10) Pub. No.: US 2026/0230899 A1
(43) Pub. Date: Aug. 6, 2026

(54) METHOD AND APPARATUS FOR CONFIGURING APPLICABILITY REPORTING IN WIRELESS COMMUNICATION SYSTEMS

(71) Applicant: Samsung Electronics Co., Ltd., Gyeonggi-do (KR)

(72) Inventors: Youn Hyoung HEO, Sunnyvale, CA (US); Seung-Beom JEONG, Seoul (KR)

(21) Appl. No.: 19/450,151

(22) Filed: Jan. 15, 2026

Related U.S. Application Data
(60) Provisional application No. 63/753,666, filed on Feb. 4, 2025.
(60) Provisional application No. 63/801,260, filed on May 7, 2025.

(51) Int. Cl. H04W 28/02; H04B 17/318; H04W 24/10; H04W 48/16; H04W 72/54

(52) U.S. Cl. CPC H04W 28/0215; H04B 17/318; H04W 24/10; H04W 28/0231; H04W 48/16; H04W 72/54

(57) ABSTRACT

A method for configuring applicability reporting between a network node and a user equipment (UE) is provided. The method including: transmitting, from the network node to the UE, configuration information including one or more configurations associated with a full configuration for inference and a partial configuration for applicability reporting; determining, at the UE, whether the configuration is applicable for inference; and reporting, from the UE to the network node, applicability information indicating one or more applicable configurations.

### CROSS-REFERENCE TO RELATED APPLICATIONS

This application claims the priority benefit under 35 U.S.C. § 119(e) of U.S. Provisional Application No. 63/753,666, filed on Feb. 4, 2025, and U.S. Provisional Application No. 63/801,260, filed on May 7, 2025, the disclosures of which are incorporated by reference in their entireties as if fully set forth herein.

### TECHNICAL FIELD

The disclosure generally relates to wireless communication systems. More particularly, the subject matter disclosed herein relates to improvements to configuring applicability reporting for AI/ML-based inference operations in user equipment (UE).

### SUMMARY

Wireless communication systems often employ configuration signaling between a network node and a UE to manage reporting and inference operations. Machine learning (ML) and artificial intelligence (AI) functions are increasingly integrated into such systems to enhance link adaptation, beam management, and performance prediction.

To support these operations, some systems use standardized configuration messages, such as channel state information (CSI) reporting configurations, that enable the network to obtain feedback from the UE for beam selection and link maintenance.

One issue with the above approach is that existing configuration frameworks do not distinguish between configurations used for applicability reporting and those used for inference, which can lead to inefficiency or ambiguity when determining whether and when specific reports should be activated.

To overcome these issues, systems and methods are described herein for configuring applicability reporting between a network node and a UE using one or more configuration formats associated with full and partial configurations, determining applicability based on received information, and selectively activating reporting functions based on applicability determinations.

The above approaches improve on previous methods because they enable flexible control of reporting behavior, reduce unnecessary signaling, and allow consistent coordination between applicability reporting and inference configuration without modifying existing reporting structures.

In an embodiment, a method for configuring applicability reporting between a network node and a UE comprises: transmitting, from the network node to the UE, configuration information including one or more configurations associated with a full configuration for inference and a partial configuration for applicability reporting; determining, at the UE, whether the configuration is applicable for inference; and reporting, from the UE to the network node, applicability information indicating one or more applicable configurations.

In an embodiment, an electronic device configured for applicability reporting comprises: a transceiver configured to transmit and receive wireless signals with a network node; and a controller operatively connected to the transceiver and configured to: receive configuration information from the network node, the configuration information including one or more configuration formats associated with a full configuration for inference and a partial configuration for applicability reporting; determine whether applicability reporting is required based on the configuration information; transmit applicability information indicating one or more applicable configurations to the network node; and activate a reporting function associated with the full configuration when applicability of the full configuration is indicated.

In an embodiment, a non-transitory computer-readable medium storing instructions that, when executed by a processor of a UE, cause the processor to perform a method for configuring applicability reporting, the method comprising: transmitting, from the UE to a network node, applicability information indicating one or more applicable configurations; receiving, at the UE from the network node, configuration information including one or more configuration formats associated with a full configuration for inference and a partial configuration for applicability reporting; determining whether applicability reporting is required based on the configuration information; and activating a reporting function associated with the full configuration when applicability of the full configuration is indicated.

### BRIEF DESCRIPTION OF THE DRAWINGS

In the following section, the aspects of the subject matter disclosed herein will be described with reference to exemplary embodiments illustrated in the figures, in which:

FIG. 1 is a diagram illustrating an example wireless communication system including a network node and UE, according to an embodiment;

FIG. 2 is a diagram illustrating an example signaling procedure for configuring applicability reporting between the network node and the UE, according to an embodiment;

FIG. 3 is a diagram illustrating an example single-format configuration for applicability reporting, according to an embodiment;

FIG. 4 is a diagram illustrating an example dual-format configuration for applicability reporting, according to an embodiment;

FIG. 5 is a flowchart illustrating an example UE-side process for activation, re-activation, and applicability change, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Applicability reporting” as used herein may refer to a procedure by which a UE informs a network node of whether one or more configured operations or reporting formats are applicable under current network or device conditions. Some examples of “applicability reporting” may include transmitting, from the UE to the network node, an indication of applicability for a configuration used in CSI reporting, inference-based measurement, or other network-controlled reporting functions; or updating the applicability status in response to performance changes, configuration updates, or re-activation triggers. “User equipment” as used herein may refer to a wireless communication device configured to transmit, receive, or process signals in communication with a network node. Some examples of “user equipment” may include a smartphone, tablet, laptop computer, wearable device, vehicle-mounted terminal, or any other electronic device capable of performing wireless communication functions such as applicability reporting, channel measurement, or inference-based data transmission. “Network node” as used herein may refer to a communication apparatus configured to manage wireless connections, transmit control information, and coordinate signaling with one or more UEs in a wireless communication system. Some examples of “network node” may include a base station, access point (AP), gNodeB (gNB), eNodeB (eNB), or any other network-side device capable of transmitting configuration information, receiving applicability reports, and controlling activation or re-activation of reporting functions. “Configuration information” as used herein may refer to control data transmitted from a network node to a UE to define parameters, formats, or conditions under which specific operations or reporting functions are to be performed. Some examples of “configuration information” may include CSI reporting configurations, inference-related configuration formats, applicability-reporting parameters, identifiers linking multiple configuration formats, or activation and re-activation indicators used to manage applicability reporting behavior.

“Full configuration for inference” as used herein may refer to a set of parameters or instructions that enable a UE to perform complete inference or measurement operations based on network-provided configuration data. Some examples of “full configuration for inference” may include a configuration defining resources, reporting periodicity, measurement types, and processing parameters for CSI reporting, beam prediction, or other AI/ML-based inference functions that utilize full network and device resources. “Partial configuration for applicability reporting” as used herein may refer to a subset of configuration parameters provided by a network node to a UE for the purpose of determining and reporting whether a corresponding full configuration is applicable under current operating conditions. Some examples of “partial configuration for applicability reporting” may include a configuration that specifies applicability-reporting triggers, thresholds, or identifiers linked to a full inference configuration, such as CSI-ReportConfig format used for indicating applicability status or initiating re-activation procedures. “Applicability information” as used herein may refer to message/information transmitted from a UE to a network node that indicates whether one or more configurations provided by the network node are currently applicable for reporting or inference operations. Some examples of “applicability information” may include a bit mask, identifier list, or message element indicating applicable configuration indexes, an applicability status flag associated with a full or partial configuration, or a re-activation indication transmitted by the UE to update the applicability state of a previously configured reporting function. “Reporting function” as used herein may refer to an operational process or module within a UE that performs transmission of measurement, inference, or applicability-related information to a network node based on configured parameters. Some examples of “reporting function” may include a periodic CSI reporting process, an event-triggered inference result transmission, or an applicability status update function that is activated, deactivated, or re-activated in response to configuration information or network control signaling.

“Single configuration format” as used herein may refer to a unified configuration structure that includes parameters for inference operations and applicability reporting within the same format transmitted from a network node to a UE. Some examples of “single configuration format” may include a combined configuration message that defines full-configuration parameters for inference and partial-configuration parameters for applicability reporting, such as a unified CSI-ReportConfig format that allows the UE to determine applicability and activate reporting without requiring separate configuration messages. “First configuration format for the full configuration” as used herein may refer to a configuration structure transmitted from a network node that defines parameters necessary for performing a complete inference or reporting operation at a UE. Some examples of “first configuration format for the full configuration” may include a CSI-ReportConfig defining measurement resources, reporting periodicity, and reference signal configurations, or an inference-related configuration that specifies processing parameters and activation conditions used by the UE to perform full inference or measurement reporting. “Second configuration format for the partial configuration” as used herein may refer to a configuration structure transmitted from a network node to a UE that defines parameters used for applicability reporting or for determining whether a corresponding full configuration is applicable. Some examples of “second configuration format for the partial configuration” may include a set-InferenceConfig or other signaling format that specifies applicability-reporting triggers, identifiers linking to a corresponding full configuration, or thresholds used by the UE to evaluate and report applicability status to the network node. “AI” as used herein may refer to artificial intelligence techniques that enable a device or system to perform tasks or make decisions based on learned patterns, data analysis, or predictive modeling. Some examples of “AI” may include machine learning algorithms used for beam prediction, channel estimation, interference management, or inference-based reporting operations performed by a UE or a network node in a wireless communication system. “ML” as used herein may refer to machine learning processes that enable a device or system to improve its performance or decision-making by training on data and identifying relationships between input and output parameters. Some examples of “ML” may include supervised, unsupervised, or reinforcement learning models applied to wireless communication tasks such as channel state prediction, beam selection, signal quality estimation, or determination of applicability for inference-based reporting in a UE or network node.

The present disclosure relates to techniques for configuring applicability reporting between a network node and a UE in a wireless communication system that supports AI/ML-based inference operations. In one example, configuration information transmitted from the network node to the UE may include one or more configuration formats associated with a full configuration for inference and a partial configuration for applicability reporting. The UE may determine whether applicability reporting is required based on the received configuration information and report applicability information indicating one or more applicable configurations to the network node. Based on the applicability indication, the UE may selectively activate a reporting function associated with the full configuration.

In some embodiments, the full and partial configurations may be represented by a single configuration format that includes parameters for both inference and applicability reporting, while in other embodiments, separate configuration formats may be employed and linked using an identifier or association field. The UE may also re-activate a previously deactivated configuration in response to a re-activation indication from the network node and may determine changes in applicability based on performance-monitoring events satisfying a threshold condition. These approaches allow flexible and efficient management of applicability reporting, supporting accurate and adaptive coordination between AI/ML-based inference functions and network control procedures.

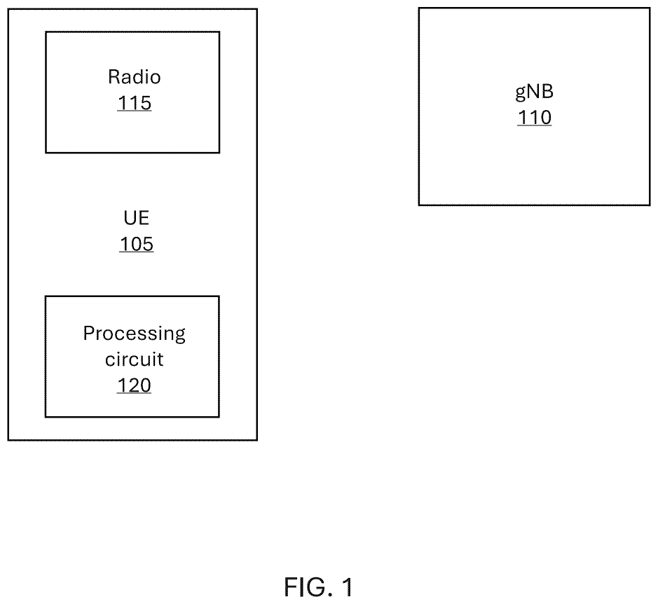

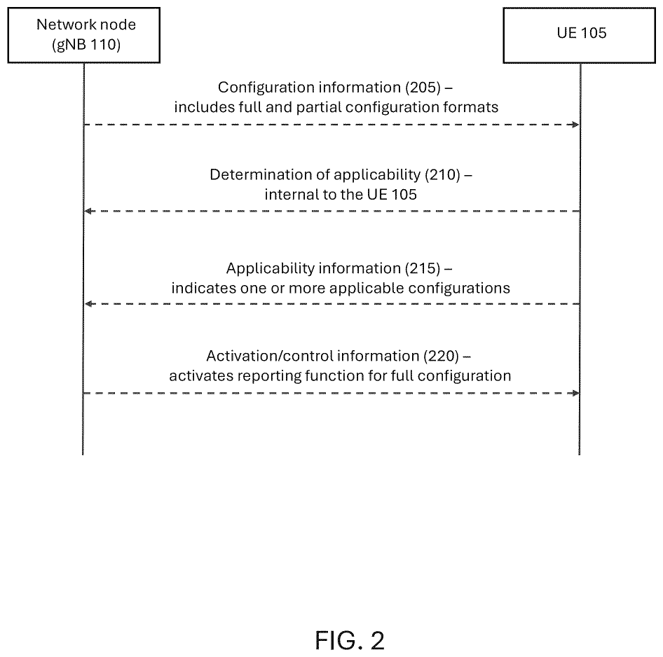

FIG. 1 illustrates an example communication system that may include a UE 105 and a network node or gNB 110 in communication with each other. The UE 105 may include a radio 115 and a processing circuit (or a means for processing) 120, which may be configured to perform one or more of the methods described herein, for example, the method illustrated in FIG. 2. The processing circuit 120 may receive, via the radio 115, configuration information and other signaling from the network node 110, and may transmit, via the radio 115, applicability information or other uplink signaling to the network node 110.

FIG. 2 is a signaling diagram illustrating an example procedure for configuring applicability reporting between a network node 110 (e.g., a base station, gNB, or another access node) and a UE 105, according to an embodiment. The illustrated procedure may include a sequence of signaling exchanges that enable the network node 110 and the UE 105 to establish and activate applicability reporting based on configuration information. Although four operations (205-220) are shown, the order of these operations may vary in other embodiments, and one or more operations may be combined, repeated, or omitted depending on network configuration or implementation constraints. While the example refers to configuration information for applicability reporting associated with ML or inference operations, the same principles may apply to other types of measurement or reporting functions.

In step 205, the network node 110 may transmit configuration information to the UE 105 to support applicability reporting. The configuration information may include one or more configuration formats that identify parameters used for inference operations (a full configuration) and parameters used for applicability reporting (a partial configuration). The transmission may occur through higher-layer control signaling such as RRC Reconfiguration or another dedicated configuration message. Each configuration format may specify a reporting period, activation condition, or measurement context associated with an inference or reporting function.

In some embodiments, the configuration information is represented by a single format that includes fields for both inference parameters and applicability-reporting parameters. For example, a single CSI-ReportConfig may contain a flag or subfield explicitly indicating whether applicability reporting is required. Alternatively, the UE 105 may determine implicitly that applicability reporting is required based on characteristics of the received configuration, such as the presence of inference-related identifiers, resource assignments, or predefined parameter values. This single-format embodiment allows the network node 110 to signal both the inference setup and the applicability-reporting requirement within one unified configuration structure.

In other embodiments, the configuration information may comprise two separate formats, for instance, a set-InferenceConfig used for applicability reporting and a CSI-ReportConfig used for the full inference configuration. The two formats may be linked by an identifier field or another reference parameter so that the UE 105 can determine which full configuration corresponds to each applicability-reporting format. The network node 110 may transmit these formats together or independently, enabling flexibility in how applicability reporting is activated and later re-activated.

The configuration information may further include control attributes defining when or how applicability reporting is to be performed, such as a timer value, periodicity, threshold condition, or event trigger. The network node 110 may selectively include these attributes depending on whether applicability reporting is expected immediately upon configuration reception or only after the UE 105 has confirmed that the configuration is applicable. The transmission in step 205 may occur during initial setup, reconfiguration, or when updated inference parameters are provisioned by the network node 110.

In step 210, the UE 105 may determine whether applicability reporting is required based on the configuration information received from the network node 110. This operation is performed by the processing circuit 120 of the UE 105 and may depend on parameters or indicators included in the configuration information transmitted in step 205. The determination of applicability enables the UE 105 to identify which configurations, among one or more received formats, are to be treated as active for inference or measurement reporting.

In one embodiment, the UE 105 may determine applicability explicitly based on a field or flag included in the received configuration. For example, the configuration format may contain an explicit information element indicating whether applicability reporting is required for the associated full configuration. In such cases, the UE 105 can directly interpret the indicator as an instruction from the network node 110 to activate the corresponding applicability-reporting function.

In another embodiment, the UE 105 may determine applicability implicitly by evaluating contextual information, such as the presence or absence of inference-related parameters, resource assignments, or scheduling references in the configuration. For instance, when the network node 110 omits a field associated with inference activation but provides only reporting-related parameters, the UE 105 may infer that the configuration corresponds to a partial configuration for applicability reporting. Conversely, when both inference and reporting parameters are included, the UE 105 may interpret the configuration as a full configuration, indicating that applicability reporting is expected.

In some embodiments, the UE 105 may evaluate multiple configuration formats, for example, a set-InferenceConfig and a CSI-ReportConfig, to determine their relationship and whether applicability reporting applies to one or both. The UE 105 may use an identifier or association field provided in the partial configuration to match it with the corresponding full configuration. Based on this association, the UE 105 can determine which configurations should be considered applicable and which should remain inactive until confirmed.

The determination process may further incorporate local performance information or historical inference results maintained by the UE 105. For example, if the UE 105 observes repeated failure conditions (e.g., poor beam prediction accuracy or unstable channel estimates) associated with a given configuration, the UE may determine that the configuration is temporarily inapplicable and withhold applicability reporting until conditions improve. Conversely, when recent measurements satisfy an applicability threshold, the UE 105 may determine that the configuration has become applicable and prepare to transmit applicability information to the network node 110.

In step 215, the UE 105 may transmit applicability information to the network node 110. The applicability information identifies one or more configurations that the UE has determined to be applicable based on the evaluation performed in step 210. The report may be conveyed using uplink control signaling such as a dedicated RRC message, a MAC control element, or a physical uplink control channel (PUCCH) report. In one example, the applicability information includes a bit mask, index list, or identifier value corresponding to the configuration formats previously provided by the network node 110. This information enables the network node 110 to understand which configurations the UE will actively use for subsequent reporting or inference operations.

In some embodiments, the UE 105 may transmit the applicability information immediately after receiving the partial configuration. This behavior corresponds to a partial-configuration mode where applicability reporting is performed without first activating the full configuration. The UE 105 may therefore indicate applicability for one or more candidate configurations even before full inference setup is completed. In other embodiments, the UE 105 may transmit the applicability information only after confirming that a full configuration is applicable, for example, by including an applicability indicator within a reconfiguration-complete message.

In embodiments where two separate configuration formats are used, the UE 105 may report the applicability of both the CSI-ReportConfig and the set-InferenceConfig even if set-InferenceConfig is provided for applicability reporting. For instance, the UE 105 may include a field indicating that the CSI-ReportConfig is applicable when linked to a specific set-InferenceConfig. The UE 105 may also report applicability changes for either format if the applicability status has changed (e.g., due to channel variation or updated performance metrics). The network node 110 to choose UE which format is used for applicability reporting i.e. the network indicates whether CSI-ReportConfig or set-InferenceConfig is used for applicability reporting.

The applicability information may further include auxiliary fields that specify the reason or criteria for applicability determination. For example, the UE 105 may indicate that a configuration is applicable because a measured beam prediction accuracy value or received signal strength exceeds a threshold. In other examples, the UE may report a counter value representing a number of successful measurements or valid inference outputs. This optional information allows the network node 110 to better understand the UE's basis for applicability reporting and to adjust configuration criteria in future updates.

In alternative embodiments, the UE 105 may combine applicability information for multiple configurations into a single report. This approach can reduce signaling overhead when many configurations are active or under evaluation. In some cases, the UE 105 may transmit applicability information periodically or upon detecting a significant change in applicability status, as determined in step 210.

In step 220, the UE 105 may activate a reporting function associated with the full configuration when the applicability of that configuration is indicated. This activation may be triggered directly by the UE 105, by a control indication from the network node 110, or by a combination of both. Once activated, the reporting function enables the UE 105 to perform periodic or event-based transmission of measurement or inference results according to the parameters defined in the full configuration. Activation ensures that reporting operations occur only for configurations that the UE 105 has confirmed as applicable, thereby avoiding unnecessary signaling and conserving processing resources.

In one embodiment, the UE 105 may activate the reporting function immediately upon reception of configuration information corresponding to a partial configuration. This behavior corresponds to a partial-configuration mode in which the UE begins applicability reporting right away and subsequently transitions to full reporting as applicability is confirmed. In another embodiment, the UE 105 may activate the reporting function only after indicating applicability to the network node 110, e.g., after transmitting the applicability information of step 215. In that case, the network node 110 may send an explicit acknowledgment or activation command confirming that the corresponding full configuration should be activated.

In certain embodiments, the network node 110 may further send an explicit activation or re-activation indication after receiving the applicability information. Such an indication may be a new RRC information element or a dedicated control signal that identifies which configurations should transition to an active state. Alternatively, the UE 105 may activate the reporting function when its internal criteria for applicability are satisfied, without waiting for a separate command. The activation indication may also specify whether the activation is initial or corresponds to a re-activation of a previously deactivated configuration.

Following activation, the UE 105 may periodically perform reporting operations or measurements defined by the full configuration (for example, periodic CSI reporting, beam prediction updates, or inference output signaling). The UE 105 may continue to monitor performance or channel conditions to determine whether the configuration remains applicable. If a degradation event or counter threshold is detected, the UE 105 may suspend or deactivate the reporting function until re-activation criteria are met. The network node 110 may also release an inactive configuration or replace it with a new configuration having updated parameters.

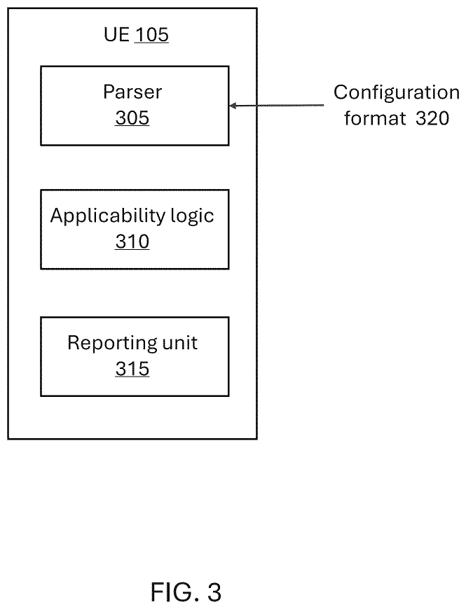

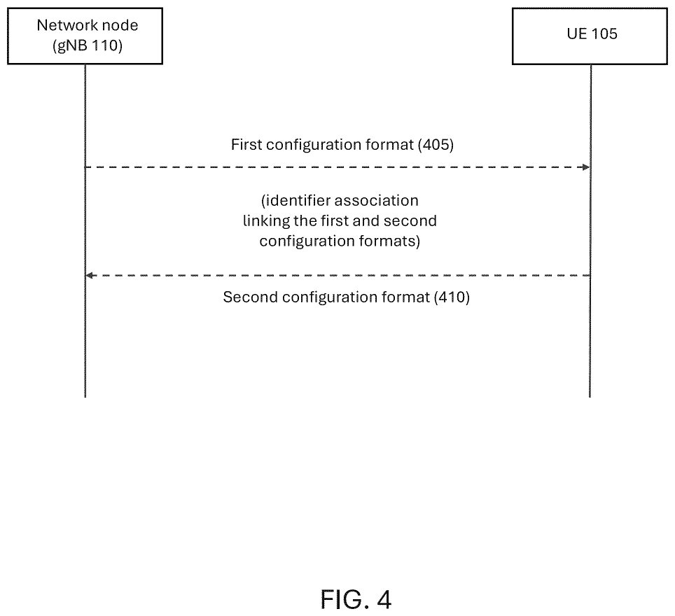

The procedure of FIG. 2 illustrates an example signaling flow that enables the network node 110 and the UE 105 to configure and activate applicability reporting in a flexible manner. Depending on implementation, the configuration information of step 205 may be represented by a single or multiple formats, and the UE 105 may determine, report, and activate applicability using either explicit or implicit signaling. Additional examples of configuration structures that support these operations are described with reference to FIGS. 3 and 4.

FIG. 3 is a block diagram illustrating an example single-format configuration for applicability reporting, according to an embodiment. As shown, the UE 105 may receive a configuration format 320 from a network node (e.g., a gNB). The configuration format 320 may include parameters corresponding to a full configuration for inference and a partial configuration for applicability reporting. Within the UE 105, the configuration format 320 may be processed by a parser 305, an applicability logic 310, and a reporting unit 315, which operate together to determine and report applicability for the received configuration.

The parser 305 may receive and decode the configuration format 320. In some embodiments, the parser 305 may extract inference-related parameters and applicability-reporting parameters from a unified structure. The extracted information may be provided to the applicability logic 310, which determines whether applicability reporting is required. The applicability logic 310 may determine applicability explicitly, based on a flag or indicator included in the configuration format 320, or implicitly, based on the presence or absence of certain configuration parameters or internal operating conditions. When applicability is indicated, the applicability logic 310 enables the reporting unit 315 to initiate or update applicability reporting operations.

The reporting unit 315 may transmit applicability information to the network node and may subsequently activate a reporting function associated with the full configuration when applicability is confirmed. This single-format embodiment enables the UE 105 to process inference and applicability parameters using a unified configuration structure, thereby reducing signaling overhead and simplifying configuration management.

FIG. 4 is a signaling diagram illustrating an example dual-format configuration for applicability reporting, according to an embodiment. As shown, a network node 110 may transmit a first configuration format 405 and a second configuration format 410 to a UE 105. The first configuration format 405 may correspond to a full configuration used for inference, while the second configuration format 410 may correspond to a partial configuration used for applicability reporting. The two configuration formats may be linked to each other through an identifier association, enabling the UE 105 to determine which partial configuration relates to which full configuration.

In one embodiment, the first configuration format 405 may include parameters that define the full inference configuration, such as channel measurement resources, reporting periodicity, and activation conditions. The second configuration format 410 may include applicability-related parameters, such as applicability reporting triggers, thresholds, or identifiers. An association field within the second configuration format 410 may reference the first configuration format 405, allowing the UE 105 to recognize that the two configurations are related. The UE 105 may thus determine whether to perform applicability reporting for a specific full configuration based on the association between the two formats.

In another embodiment, the network node 110 may transmit the first and second configuration formats either together in a single configuration message or separately at different times. When transmitted together, the UE 105 may immediately interpret the association between them. When transmitted separately, the UE 105 may temporarily store the first configuration format 405 and later link it to the second configuration format 410 upon detecting the shared identifier. This dual-format approach allows the network node 110 to configure inference and applicability reporting independently.

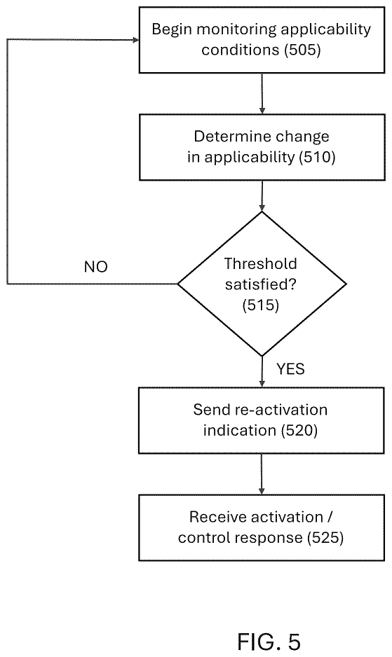

The dual-format configuration illustrated in FIG. 4 provides greater flexibility than the single-format embodiment of FIG. 3, as it allows the network node 110 to adjust applicability reporting behavior without reconfiguring the full inference setup. A corresponding procedure for activating and re-activating such configurations is described later with reference to FIG. 5.

In some embodiments, the dual-format and mixed-format configurations described with reference to FIG. 4 may be represented using explicit higher-layer signaling structures. These signaling structures enable the network node to configure applicability reporting and inference operations using either a unified format, separate formats, or a mixed operation in which each configuration element specifies which format it uses. Examples of such signaling structures are shown in Table 1 below.

TABLE 1
Example of ASN.1 signaling

| | |
|---|---|
| App-ReportConfig : : = | SEQUENCE { |
| reportFormat | CHOICE { |

```
    full-CSI- Report {
          app-ReportConfigToAddModList-r19 SEQUENCE (SIZE (1..maxNrofApp-
ReportConfig-r19))
OF CSI- ReportConfigid OPTIONAL, -- Need N
          app-ReportConfigToReleaseList-r18 SEQUENCE (SIZE (1.. maxNrofApp-
ReportConfig-r19}) OF CSI-ReportConfigid OPTIONAL, -- Need N
      set-InferenceConfig {
          app-ReportConfigToAddModList-r19 SEQUENCE (SIZE (1..maxNrofApp-
ReportConfig-r19)) OF set-InferenConfig OPTIONAL, -- Need N
        app-ReportConfigToReleaseList-r18 SEQUENCE (SIZE (1..maxNrofApp-
ReportConfig- r19}) OF set-InferenceConfigID OPTIONAL, -- Need N
    }
}
```

Alternatively, the signaling may support a mixed-format operation in which each configuration element indicates whether it uses a full-CSI-ReportConfig or a set-InferenceConfig. This allows the network node to flexibly combine applicability-reporting structures and inference-related structures within the same configuration framework.

TABLE 2
Example of ASN.1 signaling

| | |
|---|---|
| App-ReportConfigList : : = | SEQUENCE { |
| app-ReportConfigToAddModList-r19 | SEQUENCE (SIZE (1.. maxNrofApp- |
| ReportConfig-r1S)) OF App_ReportConfig | OPTIONAL, -- Need N |

app-ReportConfigToReleaseList-r18 SEQUENCE (SIZE (1...maxNrofApp-ReportConfig-
r19) } OF AppReportConfigID OPTIONAL, -- Need N
}

| | |
|---|---|
| App-ReportConfig ::= | SEQUENCE { |

```
  App-ReportConfigID,
  app-ReportFormat CHOICE {
```

| | |
|---|---|
| CSI- ReportConfigid | OPTIONAL, -- Need N |
| Set-InferenConfig | OPTIONAL, -- Need N |

}
}

These signaling examples illustrate how the network node may specify applicability-reporting and inference-related parameters using either a single unified structure, two separate structures, or a combination thereof. The UE may decode these formats to identify corresponding applicability-reporting requirements, infer association relationships between the full and partial configurations, and activate or update reporting behavior accordingly. These signaling examples may be used in conjunction with the CSI-ReportConfig structure described below.

In some embodiments, the electronic device may process inference-based CSI reporting using structured configuration parameters that specify how the device selects, measures, and reports channel state information and inference-related metrics. These parameters may be represented using a configuration sequence referred to herein as a CSI-ReportConfig, which defines resource associations, measurement resource sets, CSI reference signal configurations, and inference-related elements used for generating the inference frame or IFCS. The CSI-ReportConfig enables the UE to interpret network-provided signaling, determine the applicable measurement and reporting resources, and generate the corresponding inference data for transmission to the network node.

An example of such a configuration structure is illustrated below in Table 3. The structure includes Part A, which describes inference-related CSI configuration parameters, and Part B, which describes an optional set of inference-related parameters for an extended reporting mode. Although one example is shown, the configuration may include additional fields, fewer fields, or alternative field definitions, depending on the implementation.

TABLE 3
CSI-ReportConfig ::= SEQUENCE {
/// Part A: inference configuration

| | |
|---|---|
| reportConfigId | CSI-ReportConfigId, |
| carrier | ServCellIndex OPTIONAL, -- Need S |

| | |
|---|---|
| resourcesForChannelMeasurement | CSI-ResourceConfigId, |
| csi-IM-ResourcesForInterference | CSI-ResourceConfigId OPTIONAL, -- Need R |
| nzp-CSI-RS-ResourcesForInterference | CSI-ResourceConfigId OPTIONAL, -- Need R |

.... omitted
///Part B: a set of inference related parameters for option B

| | | |
|---|---|---|
| associatedId | AssociatedId | OPTIONAL, -- Need R |

| | |
|---|---|
| setA-information | CSI-ResourceConfigId OPTIONAL, -- Need R |

| | |
|---|---|
| setB-information | CSI-ResourceConfigId OPTIONAL, -- Need R |

}

The CSI-ReportConfig structure provides a clear definition of the measurement resources, interference resources, and inference parameter sets relevant to generating the IFCS. When the UE receives signaling that references these fields, the UE may use the identifiers to select corresponding resource sets from memory or from network-provided configuration, thereby determining which CSI-RS resources, interference measurement resources, or inference parameter groups apply to the current reporting occasion. This configuration structure can therefore be used as an input to the methods described herein, including the generation, encoding, and reporting of the inference frame.

FIG. 5 is a flowchart illustrating an example procedure for activation and re-activation of applicability reporting at a UE 105, according to an embodiment. The illustrated process may be performed after applicability reporting has been initially configured as described in FIGS. 2-4. The procedure enables the UE 105 to monitor applicability conditions, detect changes in status, and trigger activation or re-activation of a corresponding configuration when specific criteria are satisfied.

At step 505, the UE 105 may begin monitoring one or more performance conditions that are relevant to configuration applicability. The monitored conditions may include beam prediction accuracy, received signal strength, channel-quality indicators, or counter values representing repeated measurement failures. The UE 105 may maintain these parameters over time and compare them against threshold values stored locally or provided by the network node 110.

At step 510, the UE 105 may determine whether a change in applicability has occurred. This determination may be based on one or more monitored parameters crossing a threshold, or on a time-based or event-driven trigger. If the UE 105 determines that no change has occurred, the procedure returns to step 505 and continues monitoring. If the UE 105 detects that an applicability threshold has been satisfied (e.g., improvement in beam stability or restoration of link quality), the procedure proceeds to step 520.

At step 520, the UE 105 may transmit a re-activation indication to the network node 110 to signal that a previously inactive or suspended configuration should be re-activated. In some embodiments, the indication is sent as an RRC or MAC-CE message identifying the configuration to be re-activated. In response, the network node 110 may optionally send a confirmation or updated configuration message to complete re-activation (step 525). In alternative embodiments, the UE 105 may autonomously re-activate the configuration without waiting for a network response. This mechanism enables the system to maintain accurate applicability status and minimize signaling overhead when transitioning between inactive and active configurations.

The embodiments described with reference to FIGS. 1-5 illustrate examples of systems and methods for configuring and managing applicability reporting in a wireless communication system. Through the use of unified or dual configuration formats, explicit and implicit applicability determination, and controlled activation and re-activation procedures, the described approaches enable efficient coordination between the network node and the UE. These techniques may reduce signaling overhead, improve adaptability to varying channel conditions, and provide consistent control of reporting behavior across different configuration types.

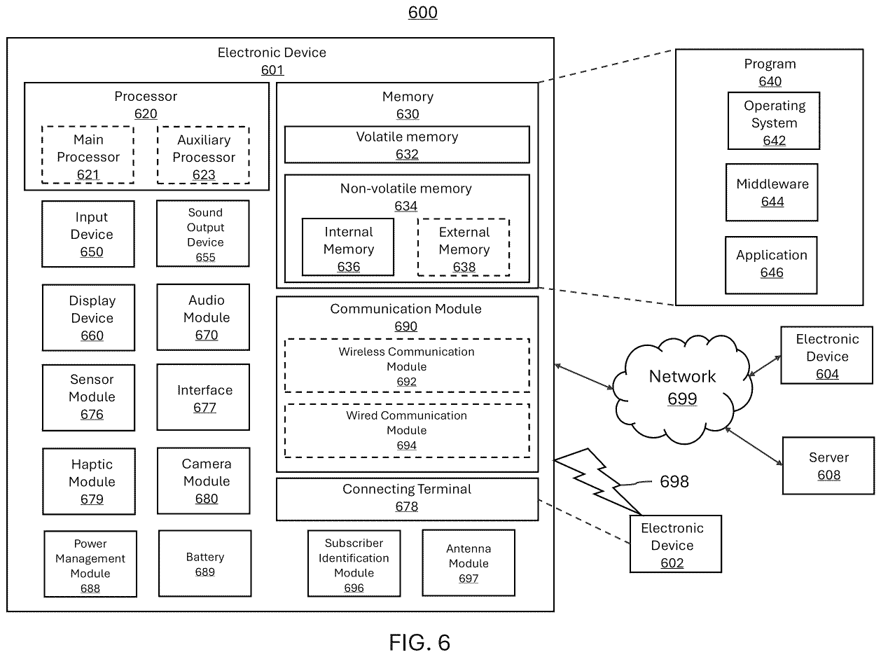

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

The electronic device 601 of FIG. 6 may correspond to, or be implemented as, the UE 105 or the network node (gNB 110) described in the preceding figures. The method steps described with reference to FIGS. 1-5, such as receiving configuration information, determining applicability, transmitting applicability information, and activating or re-activating reporting functions, may be executed by the processor 620 of the electronic device 601 based on instructions stored in the memory 630. The communication module 690 and antenna module 697 may perform wireless transmission and reception operations associated with the applicability reporting procedure between the UE 105 and the gNB 110.

The logic for performing applicability determination and reporting activation may be embodied in dedicated circuitry or firmware within the processor 620, or distributed between the processor 620 and the communication module 690. When the processor 620 executes the program 640 stored in the memory 630, the device 601 may operate as either a UE or a network node depending on the stored configuration and control instructions. Thus, FIG. 6 provides a hardware representation of the devices and components capable of carrying out the methods described in connection with FIGS. 1-5.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for configuring applicability reporting between a network node and a user equipment (UE), the method comprising:
transmitting, from the network node to the UE, configuration information including one or more configurations associated with a full configuration for inference and a partial configuration for applicability reporting;
determining, at the UE, whether the configuration is applicable for inference; and
reporting, from the UE to the network node, applicability information indicating one or more applicable configurations.

2. The method of claim 1, wherein the full configuration and the partial configuration are represented by a single configuration format that includes parameters for inference and applicability reporting.

3. The method of claim 1, wherein the configuration information includes a first configuration format for the full configuration and a second configuration format for the partial configuration, the first and second configuration formats being different from each other.

4. The method of claim 3, wherein the UE reports applicability information for the full configuration and the partial configuration.

5. The method of claim 3, the wherein the UE reports applicability information for the full configuration or the partial configuration.

6. The method of claim 4, wherein the UE receives a network (NW) indication when applicability reporting for the full configuration is allowed.

7. The method of claim 4, wherein the UE receives a network (NW) indication when applicability reporting for the partial configuration is allowed.

8. The method of claim 1, wherein the UE activates the reporting function immediately upon reception of the configuration information corresponding to the partial configuration, and activates the reporting function corresponding to the full configuration only after indicating applicability to the network node.

9. The method of claim 1, further comprising re-activating a previously deactivated configuration in response to a re-activation indication received from the network node.

10. The method of claim 1, wherein the UE determines a change in applicability based on one or more performance-monitoring events satisfying a threshold condition.

11. The method of claim 10, wherein the performance-monitoring events include at least one of: a beam-prediction accuracy value below a threshold, a received-signal-strength value below a threshold, or a counter value indicating consecutive failures exceeding a threshold number.

12. An electronic device configured for applicability reporting, comprising:
a transceiver configured to transmit and receive wireless signals with a network node; and
a controller operatively connected to the transceiver and configured to:
receive configuration information from the network node, the configuration information including one or more configuration formats associated with a full configuration for inference and a partial configuration for applicability reporting;
determine whether applicability reporting is required based on the configuration information;
transmit applicability information indicating one or more applicable configurations to the network node; and
activate a reporting function associated with the full configuration when applicability of the full configuration is indicated.

13. The electronic device of claim 12, wherein the full configuration and the partial configuration are represented by a single configuration format that includes parameters for inference and applicability reporting.

14. The electronic device of claim 12, wherein the configuration information includes a first configuration format for the full configuration and a second configuration format for the partial configuration, the first and second configuration formats being different from each other.

15. The electronic device of claim 14, wherein the second configuration format includes an identifier associated with the first configuration format, and the controller determines applicability based on an association between the identifier and the first configuration format.

16. The electronic device of claim 12, wherein the controller activates the reporting function immediately upon reception of the configuration information corresponding to the partial configuration, and activates the reporting function corresponding to the full configuration only after indicating applicability to the network node.

17. The electronic device of claim 12, wherein the controller is further configured to re-activate a previously deactivated configuration in response to a re-activation indication received from the network node.

18. The electronic device of claim 12, wherein the controller determines a change in applicability based on one or more performance-monitoring events satisfying a threshold condition.

19. A non-transitory computer-readable medium storing instructions that, when executed by a processor of a user equipment (UE), cause the processor to perform a method for configuring applicability reporting, the method comprising:
transmitting, from the UE to a network node, applicability information indicating one or more applicable configurations;
receiving, at the UE from the network node, configuration information including one or more configuration formats associated with a full configuration for inference and a partial configuration for applicability reporting;
determining whether applicability reporting is required based on the configuration information; and
activating a reporting function associated with the full configuration when applicability of the full configuration is indicated.

20. The non-transitory computer-readable medium of claim 19, wherein the full configuration and the partial configuration are represented by a single configuration format that includes parameters for inference and applicability reporting.

21. The non-transitory computer-readable medium of claim 19, wherein the configuration information includes a first configuration format for the full configuration and a second configuration format for the partial configuration, the first and second configuration formats being different from each other.

22. The non-transitory computer-readable medium of claim 19, wherein the UE activates the reporting function immediately upon reception of the configuration information corresponding to the partial configuration, and activates the reporting function corresponding to the full configuration only after indicating applicability to the network node.

23. The non-transitory computer-readable medium of claim 19, wherein the instructions cause the processor to re-activate a previously deactivated configuration in response to a re-activation indication received from the network node.

24. The non-transitory computer-readable medium of claim 19, wherein the UE determines a change in applicability based on one or more performance-monitoring events satisfying a threshold condition.
